(19) United States
(12) Patent Application Publication
(10) Pub. No.: US 2020/0005218 A1
(43) Pub. Date: Jan. 2, 2020

(54) UTILIZING SEARCH FACETS BASED ON PROJECT CONTEXT

(71) Applicant: Microsoft Technology Licensing, LLC, Redmond, VA (US)

(72) Inventors: Patrick Cheung, San Francisco, CA (US); Erik Eugene Buchanan, Mountain View, CA (US); Christine Liao, Sunnyvale, CA (US); Declan Paul Boyd, San Francisco, CA (US); Gurwinder Gulati, San Francisco, CA (US); Faith Or, Sunnyvale, CA (US); Cagri Ozcaglar, Sunnyvale, CA (US)

(21) Appl. No.: 16/023,894

(22) Filed: Jun. 29, 2018

(51) Int. Cl. G06Q 10/06; G06F 17/30

(52) U.S. Cl. CPC G06Q 10/063112; G06Q 50/01; G06F 17/30699; G06F 17/30867

(57) ABSTRACT

Disclosed herein are systems, methods, and non-transitory computer-readable media for utilizing search facets based on project context. In the system, a process is used for receiving candidate attributes from candidate devices of a plurality of candidates. The processor operates for receiving, via the network interface, user-entered attributes from a user device of a user that are a first part of project attributes of a project and storing the project attributes. The candidates are searched by comparing project attributes with candidate attributes and producing a resultant matching candidate set comprising matching candidates, wherein each matching candidate is assigned an overall matching score. The system then iteratively executes: sorting the matching candidates into sorted matching candidates, breaking the sorted matching candidates into display groups, sending a display group of the display groups to the user device, receiving a display/sort trigger, and revising the project attributes based on the display/sort trigger.

### TECHNICAL FIELD

An implementation of the present subject matter relates generally to utilizing search facets or attributes based on a project context to present the best candidates to a user for further action.

### BACKGROUND

Performing a database search and presenting the results of the search in a beneficial order for a user based on a set of user-specified criteria may not yield the best results if the user is not entirely familiar with the full extent of the domains or criteria associated with the database. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings described below.

FIG. 1 is a block diagram of an example system for utilizing search facets based on project context, according to some implementations.

FIG. 2 is a data structure diagram of an example project database, according to some implementations.

FIG. 3 is a diagram of a display based on an example screen shot of a user device for the system, according to some implementations.

FIG. 4 is a flowchart showing an example method of utilizing search facets based on project context, according to some implementations.

FIG. 5 is a block diagram illustrating an example software architecture, which may be used in conjunction with various hardware architectures herein described.

FIG. 6 is a block diagram illustrating components of a machine, according to some example embodiments, able to read instructions from a machine-readable medium (e.g., a machine-readable storage medium) and perform any one or more of the methodologies discussed herein.

FIG. 7 is a block diagram illustrating an example network architecture that may be utilized, according to some implementations.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment. The same is true when the word “implementation” and “example”.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed herein are systems, methods, and non-transitory computer-readable media for utilizing search facets based on project context. In the system, a process may be utilized for, using a processor of the system, receiving, via a network interface, candidate attributes from candidate devices of a plurality of candidates and storing them in a candidate database in a memory of the computer system. The processor operates for receiving, via the network interface, user-entered attributes from a user device of a user that are a first part of project attributes of a project and storing the project attributes in a project database in the memory. The candidates are searched for in the candidate database by comparing project attributes with candidate attributes and producing a resultant matching candidate set comprising matching candidates, wherein each matching candidate is assigned an overall matching score. The system then iteratively executes: sorting the matching candidates into sorted matching candidates by comparing the project attributes with matching candidate attributes and producing a resultant sorted matching candidate set, breaking the sorted matching candidates into display groups, sending a display group of the display groups to the user device, receiving a display/sort trigger, and revising the project attributes based on the display/sort trigger.

In the past, a user was left with their own often incorrect or incomplete knowledge as to what the ideal search and display ranking criteria might be, and therefore retrieve or rank less-than-ideal candidates. The generation and use of the context attributes and their subsequent use in order to assist the user to conduct a better database search and receive dynamic reordering of displayed search results constitutes a technical improvement in the technical field of database searching and displaying, yielding better search and display results for the user than has previously existed.

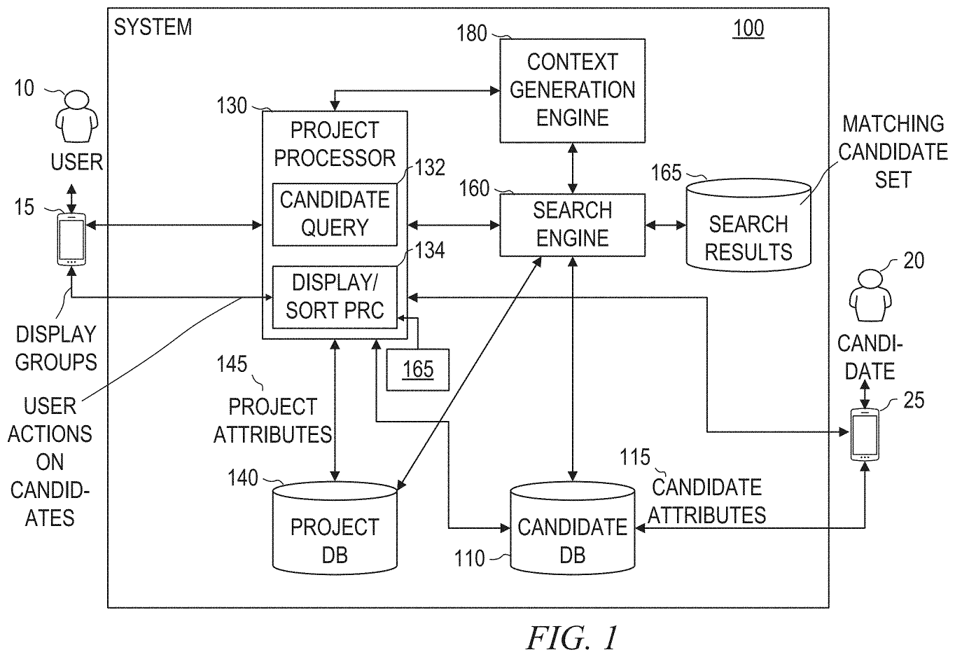

FIG. 1 is a block diagram that shows a system 100 for utilizing search facets based on project context. In the example described below, a context-based search involves a recruiter searching for suitable job candidates from a candidate pool by providing attributes of candidates of interest, and providing actions related to candidates retrieved from the search, with a display or search order being modified based on newly derived attributes. However, the system 100 is not limited to this example, and it may encompass any form of a search based upon a set of attributes or characteristics of elements in a target database.

As shown in FIG. 1, a user 10 may interact with the system 100 via a user device 15. Such a user device 15 may be any device as described below that permits a user to access and interact with the system 100. A candidate 20 may also interact with the system 100 with their own candidate device 25 that similarly may be any device as described below that permits the candidate to access and interact with the system 100. The user device 15 and the candidate device 25 may be, by way of example, a machine 600 or an end user element 710 as described in more detail below. The system 100 may be, by way of example, a system such as a data center 720 described in more detail below. A network, such as the network 706 may connect the user device 15 and the candidate device 25 with the system 100.

In this example, the candidate 20 may enter their attributes as target elements for the target database, which in the example is a candidate database 110. The candidate attributes 115 may include attributes such as identification, biometric information, skills, a job title of interest, previous jobs held, current or past industry, salary information, location information, demographic information, such as age, gender, etc. It may include any information that might be found on a resume, including key descriptive words, prior employers, education, interests. The candidate attributes 115 serve as the target criteria for a search conducted by the user 10 who is seeking one or more candidates 20 for a particular project.

A user 10, who may be a recruiter seeking one or more candidates 20, may create a project that is stored in a project database 140, or may access a project previously saved in the project database 140. An accessed project may be selected from the user's 10 own previously saved project or may be selected from a project created by another user.

The project may contain project attributes 145 that describe the candidate attributes 115 of interest for a particular job or position. The project attributes 145 may include “search facets” as described herein, but may additionally include aspects that are not included in a search (for example, the company being recruited for may be a project attribute 145 (recruit_for_company=“Acme, Inc.”), but may not necessarily be used as a part of the search). Project attributes (what is learned as constituting a good fit or bad fit for a particular role) may affect the facet suggestions that is shown to the user 10 to help the user 10 find the right candidate in the least amount of time. The project attributes 145 may comprise one or more facets each having one or more facet values. Examples of facets and facet values include the following in <facet:facet value> form: <job title: product designer, senior designer>, <locations: San Francisco Bay Area>, <skills: wireframing, sketch, design, user interface design>, <companies: Apple, Microsoft, General Motors>, <year of graduation: 2010-2018>, <schools: University of Michigan>, <industries: design, graphic design>, <keywords: NOT product manager, NOT product specialist>, <employment type>. As indicated by, e.g., the keywords facet, well-known Boolean operations and expressions may be used for any facet values or attributes. A project processor 130 may interface with the user device 15 and allow the user 10 to create or modify the project attributes 145. The project attributes and facet/facet values may include attributes such as those of the candidate attributes identified above, although there need not be a one-to-one correspondence.

Once the project attributes 145 have been created, the user may expressly execute a candidate query 132 or search in order to find one or more suitable candidates 20. The candidate query 132 may be triggered by a search trigger. The search trigger may be a response to the user 10 interacting with a display element, such as a button or other user interface element that expressly triggers a search (the candidate query 132). The search trigger may also be the loading of an existing project or a completion activity associated with creating a new project. Any other activity may be used as a search trigger as well. The general purpose behind executing a candidate query 132 at different times is because the candidates 20 in the candidate database 110 may have changed or the project attributes themselves may have changed (either user-entered attributes or generated context attributes), or both, since the last candidate query 132.

In one implementation, an initial candidate query 132 only utilizes the user entered attributes 152. However, in another example, certain generated context attributes 154 that may, for example, be quickly and easily determined, such as the software engineer, senior software engineer attribute discussed above, may be included in the initial candidate query 132. A generated context attribute 154 does not have to be generated in a current project. Rather, it can be generated based on historical data and stored in a location other than a current project and then applied to the current project attributes. For example, if the system 100 analytics have determined that a title “project engineer” combined with five or more years of experience may more properly be associated with a title “senior project engineer” based on a statistical analysis of historical data, analytics related to the candidate attributes associated with the current project need not be performed in order to add the “generated” context attribute 154 of title=senior project engineer to the current project attributes 145.

The candidate query 132 may utilize a search engine 160 that determines some measure of fit between the project attributes 145 and candidate attributes 115 of the candidates in the candidate database 110. The attribute matching does not need to be all or nothing. For example, if a project attribute is that the candidate have at least five years of experience, a candidate in the database having four years of experience might be an 80% match, and a candidate in the database having three years of experience might be a 30% match. Thus, the matching algorithm may assign varying degrees of matching between the attributes.

An overall matching score for a particular candidate may be determined based on a degree of match analysis. The degree of match analysis may be some weighted attribute or weighted factor analysis. For example, the candidate's location combined with a willingness to relocate may be much more important than the candidate's experience with a particular programming language. The weightings may be provided by the user 10, or may be empirically determined, based on some evaluation of an action, such as a user action with respect to one or more candidates, or an end result, which may be the selection by the user of a particular candidate. For example, if candidates 20 for a database programmer project are repeatedly hidden by the user 10 when they attended a particular school, a weighting associated with that school may be reduced from, e.g., a value of five to a factor value of one after repeated hiding of such candidates 20. Eventually, the weighting may be reduced to zero, meaning attribute value with a weighting of zero does not make any contribution to the overall matching score. A weighting could even take on a negative value, meaning a particular attribute value could reduce the overall matching score.

After the user 10 has initiated the candidate query 132 and the search engine 160 has located matching candidates whose candidate attributes 115 match the project attributes 145 according to some matching criteria, an overall matching score may be assigned to the candidate, and a matching candidate set may be assembled from candidates whose overall score exceeds some threshold, or assembled based on some predefined number of best scoring candidates. The matching candidate set may be stored in a search results database 165 and associated with the project. Thus, the search may determine candidate match scores for candidates in the candidate database that utilizes an attribute weighting and degree of match between one or more project attributes and corresponding candidate attributes, and the returned candidates from the search are those candidates whose candidate match score exceed a pre-determined threshold. The weighting and degree of match may be specified by the user 10, the project processor 130, or some combination of both.

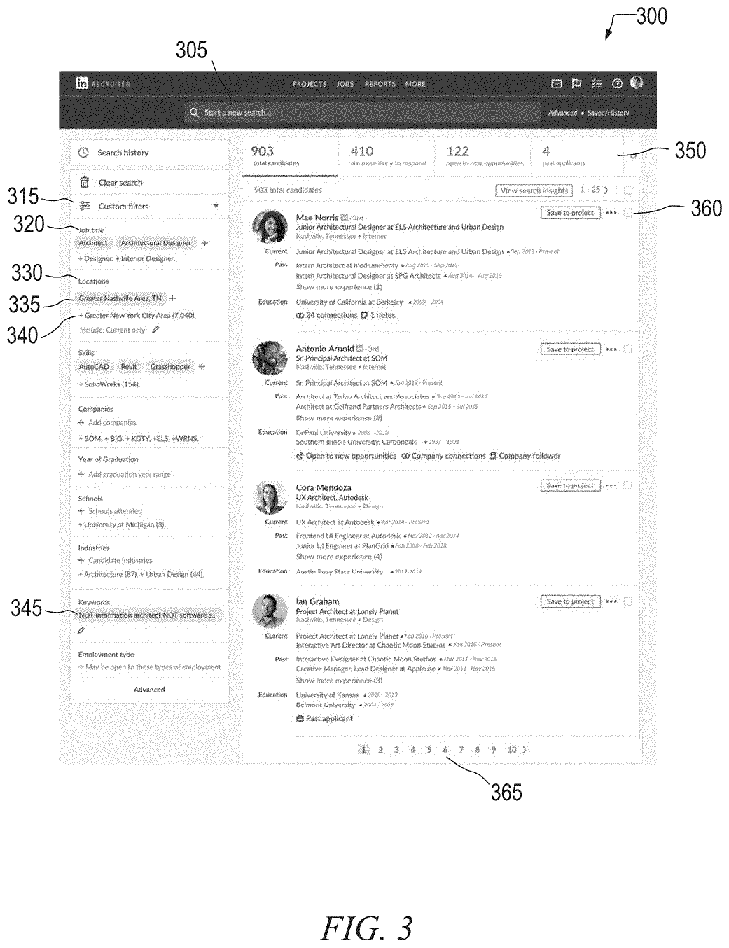

The matching candidate set may be presented to the user 10 on the user's device 15, which is described in more detail below and with respect to an example display screen shown in FIG. 3. In one implementation, the matching candidate set in the search results database 165 may be sorted from a highest matching score to a lowest matching score and broken down into display groups by a display/sort process 134. A display group may be a subset of the matching candidate set accessible to the user 10 for user operations without interruption by a search update or a sort update (discussed in more detail below), and its size may be configurable by the system 100 or user 10 (if the matching candidate set is small enough, the display group may simply be the entire matching candidate set).

The display group may be displayed within a web browser user interface or in a user interface of a dedicated application, e.g., within a displayed field or a pop-up window. Candidates 20 presented in the display group may have a set of user actions that the user 10 may be able to take with regard to the candidate 20, and certain actions may create a user designation tag for the candidate 20 that may be stored in the project database 140, or may create additional candidate information for the candidate 20 that also may be stored in the project database 140. For example, the user 10 may be able to mark a candidate 20 as a saved candidate, meaning that this candidate 20 is to be saved for future consideration or actions, and a “saved” tag may be associated with that candidate in the project database. A further tag may be associated with that candidate that directs the project processor to, e.g., take further action with regard to the candidates of interest. For example, the project processor 130 may send a candidate notification to each of the candidates 20 of interest, letting them know of the user's 10 interest in further interaction with them. For example, the interest in further interaction may be a request to set up an interview or a plant visit. The contacting of these candidates 20 of interest may be in the form of an email, a text message, and in application message, or any other mechanism for notification, such as those used for the user notification described above. The project processor 130 may track input from the candidates' 20 response to receiving notification of the user's interest, which may subsequently be used, as described below, in modifying the project context.

Similarly, the user 10 may also be able to mark the candidate 20 as “hidden” to indicate that the candidate 20 has been reviewed or considered by the user 10, but that the user has no further interest in the candidate for the current project, and a “hidden” tag may be associated with that candidate in the project database. The user 10 may add a note or comments about a particular candidate 20, and this information may be stored as additional candidate information in the project database 140. The user 10 may also be able to transfer the candidate 20 to a different project(s) for consideration, e.g., if a candidate 20 is not necessarily a good fit for the current project, but worthy of consideration in a different project. The candidate information may further include that there is no current user designation tag for the candidate 20, in which case such candidate may continue to appear in the display group of the matching candidate set until some action is taken by the user with respect to the candidate.

In one implementation, a “hidden” candidate 20 will remain hidden throughout the duration of the project. However, the user 10 may have the ability to view previously hidden candidates 20 by selecting a “view hidden candidates” option and possibly unhide a candidate 20 by selecting an “unhide” option with respect to that candidate 20. Additionally, starting a new project with the same search criteria would show the candidates 20 that were hidden in the previous project. In an implementation, as the project attributes and candidate attributes continue to evolve, it is possible that the user 10 be notified that certain hidden candidates may now be “qualified” for the particular role or project. By way of example, the user 10 initially hides a candidate for being too junior for the role or having the wrong skill set-however, if the candidate recently updated their profile, they may now, with their updated profile, be a good fit for the role.

A new display and sort 134 may be triggered by a display/sort trigger, which may be different than the search trigger discussed above. Performing a search for candidates matching the project attributes 145 from a candidate database 110 that may comprise millions of candidate records may be a resource intensive and time-consuming activity that, for these reasons, may be performed relatively infrequently. The display/sort trigger, on the other hand, may trigger the display/sort process 134 to occur on a much more limited data set of the matching candidate set in the search results 165, which may comprise on the order of dozens to a few thousand candidates 20 identified by the candidate query 132 as meeting the project attributes 145 above a certain threshold value. Thus, the display/sort process 134 may be much less resource intensive and faster than the candidate query 132, and may be done much more frequently.

However, in one implementation, the display/sort process 134 is not performed so frequently that it creates a jarring effect on the user 10. This may be the case if the display/sort process 134 were to occur with every user action or activity with respect to a candidate, causing the display to unsettlingly rearrange while the user is in the middle of working on a display group. Thus, in this implementation, the display/sort process 134 may be performed only when the user 10 changes display groups (or upon an initial display of the first display group). Put differently, a subsequent display/sort process 134 may be performed only in response to a user update action in which the user requests a display of a new display group or a refresh of the display.

The user 10 may not be sophisticated in providing the best project attributes 145 for the project that are used in the candidate query 132 or in the display/sort process 134. For example, the user 10 may indicate, as one of the project attributes 145, a project title of “software engineer”, and another of the project attributes 145 as requiring eight or more years of experience in the field. The user 10 may not realize that a project title of“senior software engineer” may be a more appropriate attribute for the project, or at least an attribute that is more likely to match with that of the desired candidate 20. This may be a problem that results in not all of the best candidates 20 being retrieved in the candidate query 132 or given a proper overall score so that they are not properly ranked or displayed in the proper order in the display/sort process 134.

In order to assist the user 10 in finding the best candidate 20 for the project, a context generation engine 180 may be utilized to determine other project attributes 145 that may be helpful in locating and/or ranking for display the most desirable candidates 20, based on various factors. In the example given above, the context generation engine 180 may deduce that most software engineers with eight years of experience will likely be classified as a “senior software engineer” for most companies, and thus add this job title attribute into the project attributes 145 that may be utilized in a subsequent search or ranking of a candidate 20.

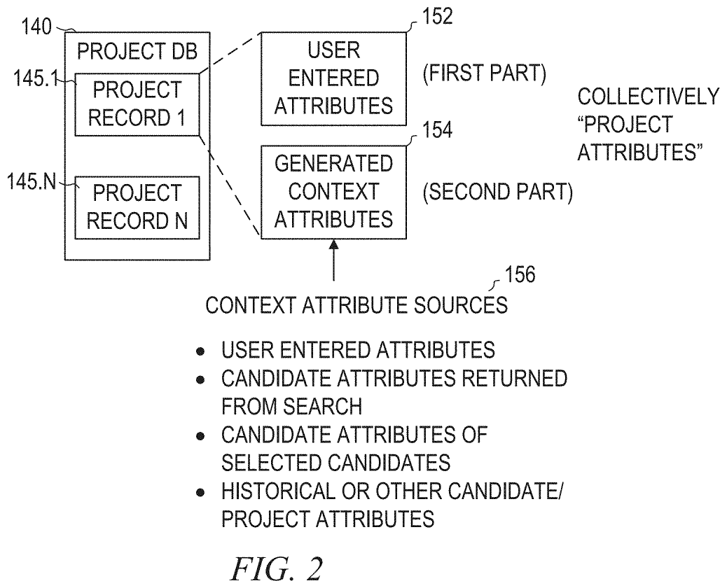

FIG. 2 is a block diagram that illustrates the project database 140 having a number of projects contained therein, illustrated by a first project attribute record 145.1 through an nth project attribute record 145.N (collectively or as an example of such record referred to with the reference numeral 145). Each project attribute record 145 may be comprised of user-entered attributes 152, and generated context attributes 154. The context attributes 154 may be determined based on the user entered attributes 152, as in the example described above. The context attributes 154 may be those that are determined in other ways besides direct user entry of the attributes and that are not present in the user-entered attributes 152.

The context attributes 154 may also be determined based on the candidate attributes returned from the candidate query 132 or based on user actions with respect to candidates 20. For example, with the software engineer and eight or more years of experience attributes provided as user entered attributes 152 for the project attributes 145, the candidates returned from the candidate query 132 may frequently have a job title of “senior software engineer” as a candidate attribute 115 associated with them. Based on this frequency of the candidate attribute 115 in the results returned from the search or based on user actions for the displayed candidates, the context generation engine 180 may determine that this is an attribute that should be added to the project attributes 145.

As discussed above, the context attributes 154 may also be determined based on the user's 10 activities with respect to the displayed candidates 20 within the set of candidates returned from the search, that is, be user behavior based. For example, when performing the initial candidate query 132 having only project attributes 145 of software engineer and eight or more years of experience, the query may return some candidates 20 having an attribute of software engineer, and other candidates 20 having an attribute of senior software engineer. If the user 10 selects mostly the candidates having the attribute of senior software engineer and does not select many candidates having the attribute of software engineer, then the context generation engine 180 may determine that senior software engineer is a better project attribute 145, than software engineer, and eliminate or deemphasize, via, e.g., a weighting, the software engineer attribute while adding or emphasizing, via, e.g., a weighting, the senior software engineer attribute. Thus, candidates with a senior software engineer attribute may receive a higher score than one with a software engineer attribute and be ranked higher in the display groups presented to the user 10.

Although the above discusses various context attributes sources 156 that may be utilized by the context generation engine 180, the system 100 is not so limited, and any measurable factors or attributes may be included in the equation. For example, attributes of those candidates 20 who interviewed successfully, and were extended an offer may impact the inclusion of or weighting of candidate attributes 115 that are included in the generated context attributes 154 of the project attributes 145 provided the events are detectable or accessible by the system 100.

Similarly, attributes of those candidates 20 who accepted the offer may impact the inclusion of attributes and weightings as well. In another example, even the employee performance characteristics post-hire may be included as well. For example, if an employee has been with the company for three years and received excellent performance reviews, their candidate attributes 115 may be considered to be good performance predictors, i.e., predictors of good employee performance, and thus be used to modify generated context attributes 154 for other similar project attributes. The context generation engine 180 may look at a specific company's historical talent pool in order to determine the generated context attributes 154. For example, the system 100 may have determined that Company A has historically, for a software engineering position, required or preferred a skill attribute being “C++ programming experience” and thus include this as a generated context attribute 154.

Although the user entered attributes 152 and the generated context attributes 154 making up the project attributes 145 may be the same for both the candidate query 132 and for the display/sort process 134, this does not have to be true. The candidate query 132 may use a different set of project attributes 145 for the initial query/search than those used for the display/sort process 134. Put differently, the user entered attributes 152 may comprise a first portion that is used for the candidate query 132 and a separate second portion that is used for the display/sort process 134. Similarly, the generated context attributes 154 may comprise a first portion that is used for the candidate query 132 and a separate second portion that is used for the display/sort process 134.

For the system 100, in one implementation, the search engine is no longer run once the candidate 20 has accepted a position identified by the project since the recruiter has achieved his or her goal in locating an employee. However, that does not mean that subsequent data related to job performance is no longer valuable with respect to similar projects, and thus historical candidate/project attributes 115, 145 may also serve as context attributes sources 156.

In one implementation, the system 100 may separately display the user-entered attributes 152 and the generated context attributes 154 so that the user 10 can see which attributes are being used to search for candidates that he/she did not expressly specify. It may further show the basis (i.e., the matching attributes and weightings) for which a particular candidate was matched.

In one implementation, the system 100 may gradually learn over time what the best project attributes 145 are to be used and their weightings based on feedback received from the attributes of selected candidates, those candidates who respond to being notified, or other of the context generation elements discussed above. The learning may be based on a job title or role, a company, a combination of job title within a company (e.g., the software engineer at company one may have a different set of context attributes than the software engineer at company two, that is, different titles may mean different things at different companies), or any other attribute or combination of attributes.

FIG. 3 is a screen shot 300 according to an implementation, illustrating an example of sorted candidate query results that have been sorted and displayed in a display group on the screen. In this implementation, a search element 305 may be utilized to start a new search. Various keywords may be entered into the search element 305 or pick lists may be provided as user-entered attributes 152. An existing project element may allow the user 10 to select a current existing project, for example, in the form of a drop-down list or a directory select/display. In one implementation, existing projects may be shared with others, and the user interface may provide a mechanism for controlling access of others to existing projects. A filter element 315 may allow the user 10 to select a variety of filters to use when performing the candidate query 132. These filters may correspond to the project attributes discussed above. The filter element 315 may also present an element for clearing all of the filters or saving the filters for a particular search in a project file. More specifically with regard to the filter element 315, a user may select a variety of groupings of facets (filters) they have saved for reuse to append to the candidate query 132. For example, the user 10 may source for multiple office locations, and thus want to save a grouping of location facets (New York, San Francisco, Chicago) to add to the search and reuse anytime.

A first filter facet 320 in the example shown is a Job title, and its facet values are Architect and Architectural Designer. An element is illustrated that permits the addition of additional facet or attribute values, along with an ability to enter Boolean expressions using the facet/attribute values. This element may also allow for the removal or cancellation of the attribute values. A second filter facet 330 in the example show is Locations, which may be a location in which the position exists and/or a location in which the candidate 20 is located. Its facet value 335 is the Greater Nashville Area in Tennessee. A potential facet value 340 may be presented to the user-in the example display shown as the Greater New York City Area. A third filter facet of Keywords is shown using Boolean logic 345, here the logic is NOT information architect NOT software architect. Any form of Boolean logic may be utilized, with the Keywords or with any of the other facets/attributes or their values.

A query summary display region 350 may be presented that shows various statistics about the candidate query 132 results returned in the matching candidate set of the search results 165. The example shows a total number of candidates, a number of candidates who are more likely to respond, a number of candidates who are open to new opportunities, and a number of past applicants. A variety of other summary information may be shown as well, and selecting one of the statistical summaries may serve as a further filter for the display. For example, selecting the displayed statistic of candidates open to new opportunities could serve as a display/sort trigger to execute the display/sort process 134, limiting the display to candidates open to new opportunities.

The grouped candidate display 360 results from execution of the display/sort process 134 and shows, in this example, a group of candidates along arranged in a one-dimensional array of candidate records. Any arrangement of candidate display is possible. Each candidate record displayed may comprise relevant summarizing information about the candidate, user interface elements for taking various actions with respect to the candidate, and other system-determined information that may be relevant about the candidate, such as whether they are open to new opportunities, company connections, whether they are a company follower, past applicant, number of connections, the presence of notes, etc.

The example grouped candidate display 360 shown in FIG. 3 may be grouped according to an average screen display size, e.g., a number of candidates that may typically be viewed on a display at once or in some easily scrollable size. Although the size shown in the example is for four candidates, such a size may vary according to screen resolution, display size, etc., and may be configured either by the system 100 or a user-specified set of parameters, and may be device dependent. For example, a smart phone display may use a different size than a 24″ desktop high resolution computer monitor. A display group selector element 365 may be provided so that the user 10 can select which display group is to be shown on the display. Selecting a different display group with the display group selector element 365 may act as a display/sort trigger that allows the sort to be performed again.

As the user takes various actions with respect to the candidates 20 and/or modifies the filters/attributes, the generated context attributes 154 may be changing as well, although in one implementation, the current display/sort process 134 would not be executed again against the modified project attributes 145 until the display/sort trigger is invoked.

It may be possible for the display to provide an indication as to the underlying analysis as to why a given candidate 20 was either retrieved from the candidate database 110 during the candidate query 132, or given a particular ranking on the display based on the display/sort process 134. In one implementation, individual candidate 20 scores may be displayed, and in a further implementation, each of the project attributes and optionally, their weightings may be displayed, including information as to whether the attribute is a user-entered attribute 152 or a generated context attribute 154.

The system 100 may utilize different degrees of transparency with regard to the use of generated context attributes 154. In one implementation with a very high degree of transparency, the project processor 130 may determine a possibility of utilizing a generated context attribute 154 and then send the user 10 a prompt asking if the user would like to add the generated context attribute 154 to the project attributes for either the candidate query 132 or the display/sort process 134. If the user 10 confirms the addition, then this attribute may be added to the generated context attributes. If the user 10 indicates the addition should not be used, then the addition is not added to the generated context attributes. In one implementation, an indicator is placed in the project database for the current project indicating the user 10 has declined the addition of this attribute so that the user is not asked about adding this attribute again.

In addition to asking the user 10 about adding a specific attribute, the display may provide a number of potential attributes to add to the project attributes 145, and the user 10 can select the desired ones and ignore or otherwise deselect the use of others. In this very high degree of transparency implementation, the user 10 is made aware of the possibility of using generated context attributes 154 and allows, or not, their use.

In another implementation, with a lesser level of transparency, the system 100 may not expressly indicate the generated context attributes 154 expressly, but may provide additional candidates 20 or present candidates from the matching candidate set having a lower score for consideration by the user. In essence, the system 100 would be saying, “since you liked/saved/took a positive action with respect to these candidates, we think you may like these other candidates as well”. Thus, the system 100 is inferring that it may be utilizing other criteria (the generated context attributes 154) other than those the user provided (the user-entered attributes 152) without expressly indicating to the user what the other criteria are.

In another implementation with an even lesser level of transparency, the system 100 may override the user's actual query or display/sort attributes and substitute, possibly using artificial intelligence, query or sort attributes of its own. In an example presented above, if the user enters title=project engineer, experience=5 or more years, the system 100 may simply ignore the user's 10 attributes and use title=senior project engineer without informing the user of the underlying logic change. In this implementation, from the user's 10 perspective, the query and sorting appears to be a black box, with little or no information related to what and how the actual search and sort project attributes are being used to produce the displayed groups and the ordering.

The generated context attributes 154 as described herein are not limited to a single attribute, factor, facet, facet value, weighting, or other designation to one criteria, but may also be a combination of attributes utilizing Boolean expressions and combining multiple attributes, factors, facets, facet values, weightings, or other designations. By way of example, any conjunction of multiple attributes may be used when determining the context, rather than only restricting it to combining multiple attributes (e.g. (attribute1) and (attribute2) or (not attribute3)).

In one implementation, the system 100 may be able to add generated context attributes 154 (or remove them, or remove user-entered attributes 132) for the candidate query 132 until a reasonable number of candidates 20 are retrieved. If the user-entered attributes 152 retrieve too small of a matching candidate set, then various user-entered attributes 152 may be removed or replaced with some other attribute. If the user-entered attributes 152 retrieve too large of a matching candidate set, then generated context attributes 154 may be added or replaced (user-entered attributes may be replaced) with some other attribute. This reasonable number may be specified by the user 10 or predetermined by the system, based on some criteria, such as empirical data of typical matching candidate sets or target recall sets.

In the event that an action from the user 10 for a particular candidate 20 is to contact the candidate 20 for further interaction, such as in the form of a request for an interview, in one implementation, the system 100 may be able to provide a template for communicating with the candidate 20 that is most likely, based on prior analytics, to get a response from the candidate 20. This determination may be made based on performing a statistical analysis on prior candidates 20 receiving invitations who accepted them, and wording of the communications sent to them, verses prior candidates 20 receiving invitations who rejected them. These analytics may include word choices, specific sentences, mode of communication, etc.

In one implementation, the system 100 may, for a present candidate 20 that the user 10 has indicated an interest in following up with, ask the user 10 if they would like to see more candidates similar to the present candidate 20, and if so, either execute a new candidate query 132 or perform a display/sort process 134 utilizing that attributes of the present candidate as the project attributes, or at least giving such attributes greater weight.

In one implementation, the system 100 may be configured to detect an inadvertent project switching by the user 10 and prompt the user when such a switching is detected. For example, if a user is working on a project for a software engineer, but starts entering facets/attributes or values that appear to be inconsistent with other project parameters, such as a skill “tax accounting”, the system 100 may ask the user 10 whether she is still intending to be working on the software engineer project. Such an assessment could be made by the system based on analyzing a degree of overlap of attributes being entered with those already entered or those determined by the system to be consistent with a particular job title or other project attribute.

Although the above has described activities of the system 100 with respect to a search for a single candidate 20 for a single role or position, nothing prevents the system from applying the same principles to a project team. For example, a company wishing to expand its laboratory to include new biological specimen processing may be looking to hire a biologist in the field along with a supporting assistant and records manager. Although such an expanded system could simply treat and manage these as three separate candidate projects, by utilizing a project to manage a project team could take into account factors such as whether individuals on the team have worked together before, and consider complementary roles (e.g., strengths of one team member compensating for the weaknesses of another, and vice versa).

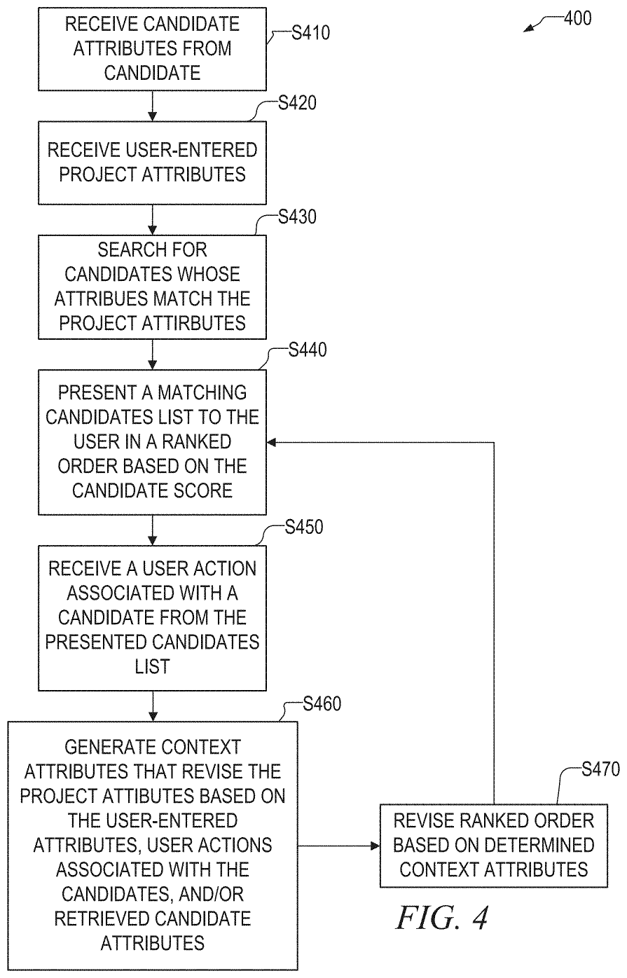

FIG. 4 is a flowchart that illustrates an example process 400 that may be utilized to operate the system 100 described above. In operation S410 the system 100 may receive candidate attributes 115 from a candidate 20 via a network-connected candidate device 25. Although operation S410 is shown as occurring at the start of the process, this operation may be ongoing throughout the life of the project, as candidates themselves may be signing on continuously, creating a changing candidate pool from which the users 10 may search.

In operation S420, the system may receive user-entered (project) attributes 152 that are desired to match with candidate attributes. As with operation S410, the user 10 may change the user-entered attributes 152 at any time during the project. These user-entered attributes 152 may be stored in a project record 145.1 in the project database 140.

In operation S430, a search is performed, as described above for candidates 20 whose candidate attributes 115 match with the project attributes 145, according to some formula and threshold that may weight the importance of the various attributes. The search may be triggered by a search trigger. The search trigger may be a user operation performed by the user 10 who initiates via the user device 15 by, for example, by interacting with a display on their device, by, e.g., clicking a button or selecting a displayed menu item or the like. The search trigger be a system trigger that triggers the search. In one example, this system trigger may be a system operation that is an expiration of a timer so that the search is performed periodically, such as once per day. In another example, this system trigger might be the completion of an activity, such as the creation of a new project attribute 145 (either a user-entered attribute 152 or a generated context attribute 154) or by the input of a certain number of new candidates 20 or the like.

In one implementation, the search trigger may also be invoked by changing a formula, for example, changing the machine learning model or approach in the backend. Broadly speaking, in some implementations, a search trigger may be invoked by: information from the user (changes to project attributes, saving or hiding various candidates, clicks or InMail (application-based) sends on candidates, actions within hiring pipelines, actions of other users in general, for example, the actions of recruiters not within the same project/company, or a candidate who updates their own information), or a change in information processing in the backend (change in the machine learning model, or using more types of information from the user). A search trigger may further be invoked to more broadly re-evaluate with the heuristic that the information used to make the suggestions may have changed (based on time, or number of actions taken on candidates within a project, etc.). The result of the search is a set of matched candidates 20 whose candidate attributes 115 match the project attributes 145 according to some formula. The search trigger, based on a project attribute-candidate attribute match, may produce a predefined number of final candidates to be displayed in the search.

In operation S440, the set of matched candidates 20 is presented to the user 10 in such a way as to be selectable by the user 10, such as by presenting the set in a list on the user's display screen with a selection element such as a checkbox or button next to each candidate 20 in the set. The candidates 20 returned from the search (the matching candidate set) are ranked according to a candidate scoring, as described above, and broken in display groups that are presented to the user 10 on their device 15 in ranked order.

In operation S450, the system 100 receives from the user 10 a user action with respect to a candidate 20, such as save or hide, as described above. In operation S460, the system 100 may generate context attributes 154 that revise the project attributes 145 based on factors that may include one or more of: user-entered attributes 152, user actions associated with the candidates of the matching candidate set, or retrieved candidate attributes from the matching candidate set.

In operation S470, the ranked order of the candidates is revised, based on a candidate score determined by utilizing the revised project attributes, and revised candidate groups ranked according to the revised candidate score are presented, looping to operation S440 on the user's device 15.

The project record 145.1 may contain a list of the candidates 20 who have already been seen and/or acted on by the user 10 so that the user 10 is not presented with a candidate multiple times. The underlying candidate 20 pool is also constantly changing, so even if the project attributes 145 have not changed, a new set of matched candidates may still be produced based on candidates 20 newly added to the candidate pool when the candidate query 132 is executed. In one example, a configurable flag or other control may be used to indicate whether only new (unseen) candidates 20 are presented to the user 10 for a given search, or whether all candidates 20, including those already seen by the user 10.

The project attributes 145, both the user-entered attributes 152 and the generated context attributes 154, could have their weighting factors change as well in order to emphasize and deemphasize various attributes. As defined herein, use of the term of project attributes 145 may include these attributes or factors, along with their weighting.

The process may terminate at any time and according to any predefined criteria. However, once the project goals (e.g., a suitable candidate was selected, notified of desired further contact, and responded) have been achieved, the project may become dormant and no longer perform searches and updates on candidate sets.

### Software & System Architecture

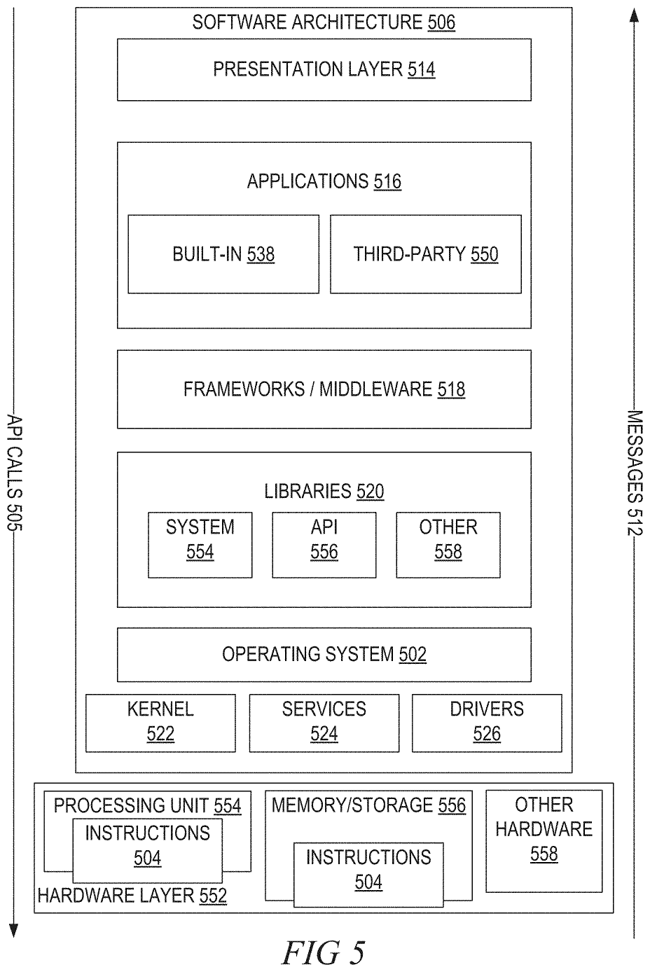

FIG. 5 is a block diagram illustrating an example software architecture 506, which may be used in conjunction with various hardware architectures herein described. FIG. 5 is a non-limiting example of a software architecture 506 and it will be appreciated that many other architectures may be implemented to facilitate the functionality described herein. The software architecture 506 may execute on hardware such as machine 500 of FIG. 5 that includes, among other things, processors 504, memory 514, and (input/output) I/O components 518. A representative hardware layer 552 is illustrated and can represent, for example, the machine 500 of FIG. 5. The representative hardware layer 552 includes a processing unit 554 having associated executable instructions 504. Executable instructions 504 represent the executable instructions of the software architecture 506, including implementation of the methods, components, and so forth described herein. The hardware layer 552 also includes memory and/or storage modules memory/storage 556, which also have executable instructions 504. The hardware layer 552 may also comprise other hardware 558.

In the example architecture of FIG. 5, the software architecture 506 may be conceptualized as a stack of layers where each layer provides particular functionality. For example, the software architecture 506 may include layers such as an operating system 502, libraries 520, frameworks/middleware 518, applications 516, and a presentation layer 514. Operationally, the applications 516 and/or other components within the layers may invoke API calls 508 through the software stack and receive a response such as messages 512 in response to the API calls 508. The layers illustrated are representative in nature and not all software architectures have all layers. For example, some mobile or special purpose operating systems may not provide a frameworks/middleware 518, while others may provide such a layer. Other software architectures may include additional or different layers.

The operating system 502 may manage hardware resources and provide common services. The operating system 502 may include, for example, a kernel 522, services 524, and drivers 526. The kernel 522 may act as an abstraction layer between the hardware and the other software layers. For example, the kernel 522 may be responsible for memory management, processor management (e.g., scheduling), component management, networking, security settings, and so on. The services 524 may provide other common services for the other software layers. The drivers 526 are responsible for controlling or interfacing with the underlying hardware. For instance, the drivers 526 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 520 provide a common infrastructure that is used by the applications 516 and/or other components and/or layers. The libraries 520 provide functionality that allows other software components to perform tasks in an easier fashion than to interface directly with the underlying operating system 502 functionality (e.g., kernel 522, services 524 and/or drivers 526). The libraries 520 may include system libraries 544 (e.g., C standard library) that may provide functions such as memory allocation functions, string manipulation functions, mathematical functions, and the like. In addition, the libraries 520 may include API libraries 546 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 520 may also include a wide variety of other libraries 548 to provide many other APIs to the applications 516 and other software components/modules.

The frameworks/middleware 518 (also sometimes referred to as middleware) provide a higher-level common infrastructure that may be used by the applications 516 and/or other software components/modules. For example, the frameworks/middleware 518 may provide various graphic user interface (GUI) functions, high-level resource management, high-level location services, and so forth. The frameworks/middleware 518 may provide a broad spectrum of other APIs that may be used by the applications 516 and/or other software components/modules, some of which may be specific to a particular operating system 502 or platform.

The applications 516 include built-in applications 538 and/or third-party applications 540. Examples of representative built-in applications 538 may include, but are not limited to, a contacts application, a browser application, a book reader application, a location application, a media application, a messaging application, and/or a game application. Third-party applications 540 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 540 may invoke the API calls 508 provided by the mobile operating system (such as operating system 502) to facilitate functionality described herein.

The applications 516 may use built in operating system functions (e.g., kernel 522, services 524 and/or drivers 526), libraries 520, and frameworks/middleware 518 to create user interfaces to interact with users of the system. Alternatively, or additionally, in some systems, interactions with a user may occur through a presentation layer, such as presentation layer 514. In these systems, the application/component “logic” can be separated from the aspects of the application/component that interact with a user.

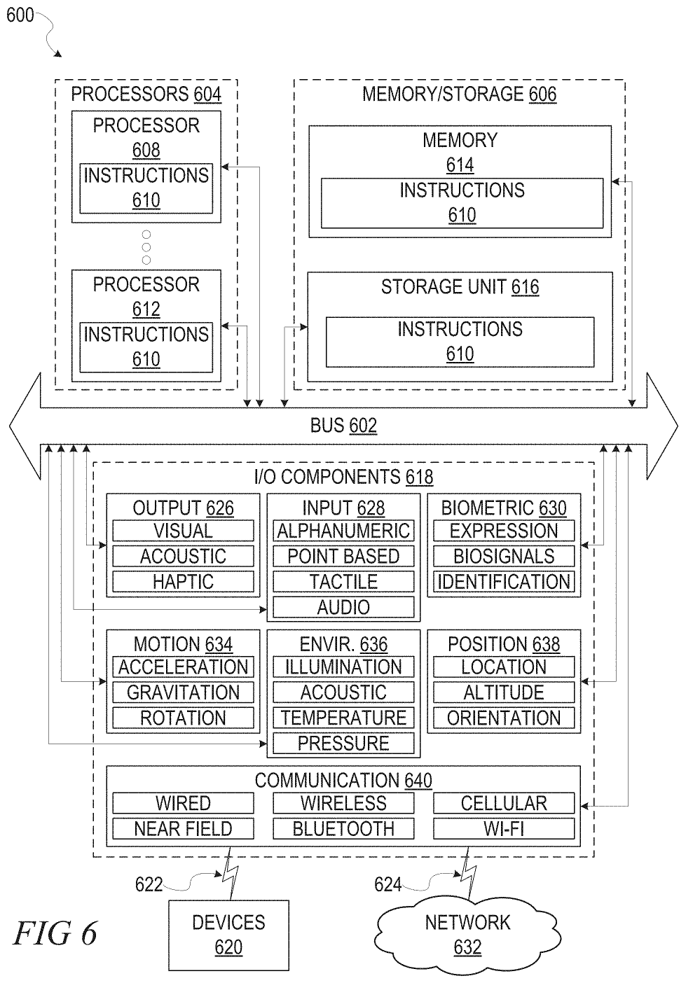

FIG. 6 is a block diagram illustrating components of a machine 600, according to some example embodiments, able to read instructions 804 from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 610 (e.g., software, a program, an application, an applet, an app, or other executable code) for causing the machine 600 to perform any one or more of the methodologies discussed herein may be executed. As such, the instructions 610 may be used to implement modules or components described herein. The instructions 610 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 600 capable of executing the instructions 610, sequentially or otherwise, that specify actions to be taken by machine 600. Further, while only a single machine 600 is illustrated, the term “machine” shall also be taken to include a collection of machines that individually or jointly execute the instructions 610 to perform any one or more of the methodologies discussed herein.

The machine 600 may include processors 604, memory/storage 606, and I/O components 618, which may be configured to communicate with each other such as via a bus 602. The memory/storage 606 may include a memory 614, such as a main memory, or other memory storage, and a storage unit 616, both accessible to the processors 604 such as via the bus 602. The storage unit 616 and memory 614 store the instructions 610 embodying any one or more of the methodologies or functions described herein. The instructions 610 may also reside, completely or partially, within the memory 614, within the storage unit 616, within at least one of the processors 604 (e.g., within the processor's cache memory), or any suitable combination thereof, during execution thereof by the machine 600. Accordingly, the memory 614, the storage unit 616, and the memory of processors 604 are examples of machine-readable media.

The I/O components 618 may include a wide variety of components to receive input, provide output, produce output, transmit information, exchange information, capture measurements, and so on. The specific I/O components 618 that are included in a particular machine 600 will depend on the type of machine. For example, portable machines such as mobile phones will likely include a touch input device or other such input mechanisms, while a headless server machine will likely not include such a touch input device. It will be appreciated that the I/O components 618 may include many other components that are not shown in FIG. 6. The I/O components 618 are grouped according to functionality merely for simplifying the following discussion and the grouping is in no way limiting. In various example embodiments, the I/O components 618 may include output components 626 and input components 628. The output components 626 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 628 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 618 may include biometric components 630, motion components 634, environmental components 636, or position components 638 among a wide array of other components. For example, the biometric components 630 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 634 may include acceleration sensor components (e.g., accelerometer), gravitation sensor components, rotation sensor components (e.g., gyroscope), and so forth. The environmental components 636 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 618 may include communication components 640 operable to couple the machine 600 to a network 632 or devices 620 via coupling 624 and coupling 622, respectively. For example, the communication components 640 may include a network interface component or other suitable device to interface with the network 632. In further examples, communication components 640 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 620 may be another machine or any of a wide variety of peripheral devices (e.g., a peripheral device coupled via a USB).

Moreover, the communication components 640 may detect identifiers or include components operable to detect identifiers. For example, the communication components 640 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 610 for execution by the machine 600, and includes digital or analog communications signals or other intangible medium to facilitate communication of such instructions 610. Instructions 610 may be transmitted or received over the network 632 using a transmission medium via a network interface device and using any one of a number of well-known transfer protocols.

“CLIENT DEVICE” in this context refers to any machine 600 that interfaces to a communications network 632 to obtain resources from one or more server systems or other client devices. A client device may be, but is not limited to, a mobile phone, desktop computer, laptop, PDAs, smart phones, tablets, ultra books, netbooks, laptops, multi-processor systems, microprocessor-based or programmable consumer electronics, game consoles, STBs, or any other communication device that a user may use to access a network 632.

“COMMUNICATIONS NETWORK” in this context refers to one or more portions of a network 632 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 632 or a portion of a network 632 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 610 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 610. The term “machine-readable medium” shall also be taken to include any medium, or combination of multiple media, that is capable of storing instructions 610 (e.g., code) for execution by a machine 600, such that the instructions 610, when executed by one or more processors 604 of the machine 600, cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 604) may be configured by software (e.g., an application 816 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 604 or other programmable processor 604. Once configured by such software, hardware components become specific machines 600 (or specific components of a machine 600) uniquely tailored to perform the configured functions and are no longer general-purpose processors 604. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 604 configured by software to become a special-purpose processor, the general-purpose processor 604 may be configured as respectively different special-purpose processors (e.g., comprising different hardware components) at different times. Software accordingly configures a particular processor or processors 604, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 602) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 604 that are temporarily configured (e.g., by software) or permanently configured to perform the relevant operations. Whether temporarily or permanently configured, such processors 604 may constitute processor-implemented components that operate to perform one or more operations or functions described herein. As used herein, “processor-implemented component” refers to a hardware component implemented using one or more processors 604. Similarly, the methods described herein may be at least partially processor-implemented, with a particular processor or processors 604 being an example of hardware. For example, at least some of the operations of a method may be performed by one or more processors 604 or processor-implemented components. Moreover, the one or more processors 604 may also operate to support performance of the relevant operations in a “cloud computing” environment or as a “software as a service” (SaaS). For example, at least some of the operations may be performed by a group of computers (as examples of machines 600 including processors 604), with these operations being accessible via a network 632 (e.g., the Internet) and via one or more appropriate interfaces (e.g., an API). The performance of certain of the operations may be distributed among the processors 604, not only residing within a single machine 600, but deployed across a number of machines 600. In some example embodiments, the processors 604 or processor-implemented components may be located in a single geographic location (e.g., within a home environment, an office environment, or a server farm). In other example embodiments, the processors 604 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 600. A processor 604 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 604 (sometimes referred to as “cores”) that may execute instructions 610 contemporaneously.

### Network Architecture

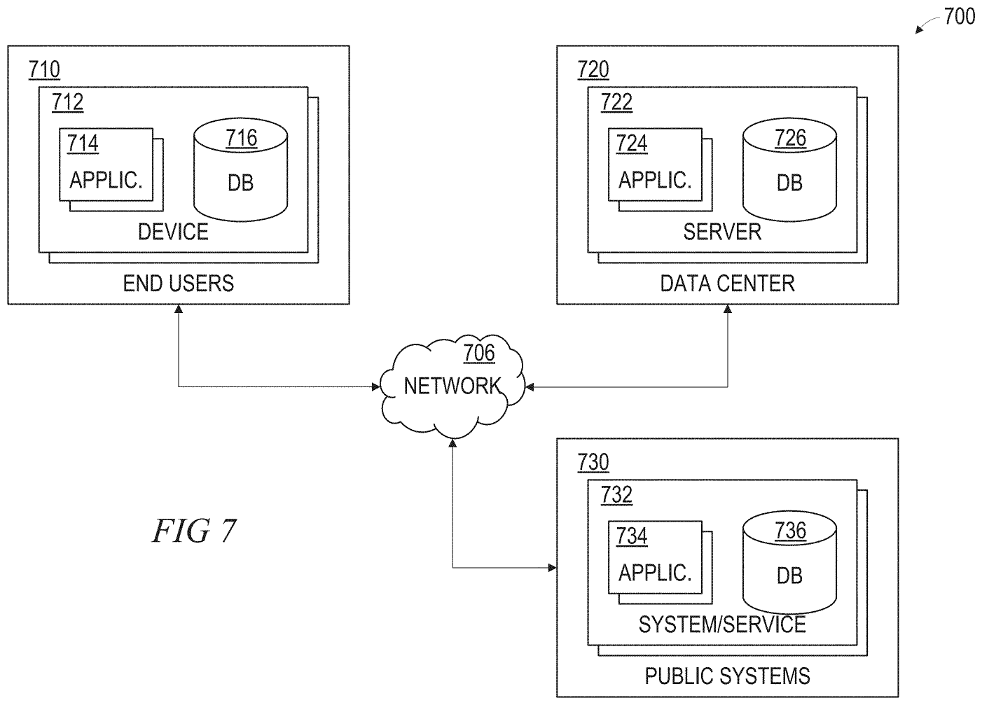

FIG. 7 is a block diagram of a distributed system 700 that may include a client-server architecture or cloud computing system. The system 700 may be a system 100 as described above. Distributed system 700 may have one or more end users 710. An end user 710 may have various computing devices 712, which may be machines 600 as described above. The end-user computing devices 712 may comprise applications 714 that are either designed to execute in a stand-alone manner, or interact with other applications 714 located on the device 712 or accessible via the network 605. These devices 712 may also comprise a data store 716 that holds data locally, the data being potentially accessible by the local applications 714 or by remote applications.

The system 700 may also include one or more data centers 720. A data center 720 may be a server 722 or the like associated with a business entity that an end user 710 may interact with. The business entity may be a computer service provider, as may be the case for a cloud services provider, or it may be a consumer product or service provider, such as a retailer. The data center 720 may comprise one or more applications 724 and databases 726 that are designed to interface with the applications 714 and databases 716 of end-user devices 712. Data centers 720 may represent facilities in different geographic locations where the servers 722 may be located. Each of the servers 722 may be in the form of a machine(s) 300.

The system 700 may also include publicly available systems 730 that comprise various systems or services 732, including applications 734 and their respective databases 736. Such applications 734 may include news and other information feeds, search engines, social media applications, and the like. The systems or services 732 may be provided as comprising a machine(s) 300.

The end-user devices 712, data center servers 722, and public systems or services 732 may be configured to connect with each other via the network 305, and access to the network by machines may be made via a common connection point or different connection points, e.g. a wireless connection point and a wired connection. Any combination of common or different connections points may be present, and any combination of wired and wireless connection points may be present as well. The network 305, end users 710, data centers 720, and public systems 730 may include network hardware such as routers, switches, load balancers and/or other network devices.

Other implementations of the system 700 are also possible. For example, devices other than the client devices 712 and servers 722 shown may be included in the system 700. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 722.

What is claimed is:

1. A method comprising, with a processor of a computer system:
receiving, via a network interface, candidate attributes from candidate devices of a plurality of candidates and storing them in a candidate database in a memory of the computer system;
receiving, via the network interface, user-entered attributes from a user device of a user that are a first part of project attributes of a project and storing the project attributes in a project database in the memory;
searching for candidates in the candidate database by comparing project attributes or search facets with candidate attributes and producing a resultant matching candidate set comprising matching candidates, wherein each matching candidate is assigned an overall matching score;
iteratively executing:
sorting the matching candidates into sorted matching candidates by comparing the project attributes with matching candidate attributes and producing a resultant sorted matching candidate set;
breaking the sorted matching candidates into display groups;
sending a display group of the display groups to the user device;
receiving a display/sort trigger; and
revising the project attributes based on the display/sort trigger.

2. The method of claim 1, wherein the display/sort trigger comprises a changing of the project attributes.

3. The method of claim 2, wherein the changing of the project attributes results from a creation or changing of generated context attributes of the project attributes.

4. The method of claim 3, wherein the changing of the generated context attributes is based on at least one of the user-entered attributes, the matching candidate attributes, candidate attributes of the selected candidate, candidate attributes of historical candidates, a user action related to a displayed candidate of the display group, or project attributes of an additional project.

5. The method of claim 4, wherein the user action is at least one of: saving the candidate or hiding the candidate.

6. The method of claim 3, further comprising:
sending a potential context attribute to the user;
receiving a favorable indication for using the potential context attribute from the user; and
performing the changing of the project attributes in response to the receiving of the favorable indication.

7. The method of claim 3, wherein the changing of the generated context attributes is based on candidate attributes of candidates who performed at least one of: accepting a request for further contact by the user or receiving an offer.

8. The method of claim 1, further comprising:
sending a new display group of the display groups to the user device in response to a user update action requesting a display of the new display group; and
executing a new iteration of the iteratively executing operations only in response to the user update action.

9. The method of claim 1, further comprising modifying the project attributes until a predetermined number of matching candidates are received from the searching.

10. A system comprising:
one or more computer processors
a memory; and
one or more computer-readable mediums storing instructions that, when executed by the one or more computer processors, cause the system to:
receive, via a network interface, candidate attributes from candidate devices of a plurality of candidates and storing them in a candidate database in the memory;
receive, via the network interface, user-entered attributes from a user device of a user that are a first part of project attributes of a project and storing the project attributes in a project database in the memory;
search for candidates in the candidate database by comparing project attributes or search facets with candidate attributes and produce a resultant matching candidate set comprising matching candidates, wherein each matching candidate is assigned an overall matching score;
iteratively execute, causing the system to:
sort the matching candidates into sorted matching candidates by a compare of the project attributes with matching candidate attributes and produce a resultant sorted matching candidate set;
break the sorted matching candidates into display groups;
send a display group of the display groups to the user device;
receive a display/sort trigger; and
revise the project attributes based on the display/sort trigger.

11. The system of claim 10, wherein the display/sort trigger comprises a changing of the project attributes.

12. The system of claim 11, wherein the change of the project attributes results from a creation or change of generated context attributes of the project attributes.

13. The system of claim 12, wherein the change of the generated context attributes is based on at least one of the user-entered attributes, the matching candidate attributes, candidate attributes of the selected candidate, candidate attributes of historical candidates, a user action related to a displayed candidate of the display group, or project attributes of an additional project.

14. The system of claim 13, wherein the user action is at least one of: saving the candidate or hiding the candidate.

15. The system of claim 12, wherein the one or more processors is further configured to:
send a potential context attribute to the user;
receive a favorable indication for use of the potential context attribute from the user; and
perform the change of the project attributes in response to the receipt of the favorable indication.

16. The system of claim 12, wherein the change of the generated context attributes is based on candidate attributes of candidates who performed at least one of: accepted a request for further contact by the user or received an offer.

17. The system of claim 10, wherein the one or more processors is further configured to:
send a new display group of the display groups to the user device in response to a user update action of a request for a display of the new display group; and
executes new iteration of the iteratively executing operations only in response to the user update action.

18. The system of claim 10, wherein the one or more processors is further configured to modify the project attributes until a predetermined number of matching candidates are received from the searching.

19. A non-transitory computer-readable medium storing instructions that, when executed by one or more computer processors of a computing device, cause the computing device to perform operations comprising:
receiving, via a network interface, candidate attributes from candidate devices of a plurality of candidates and storing them in a candidate database in a memory of the computer system;
receiving, via the network interface, user-entered attributes from a user device of a user that are a first part of project attributes of a project and storing the project attributes in a project database in the memory;
searching for candidates in the candidate database by comparing project attributes or search facets with candidate attributes and producing a resultant matching candidate set comprising matching candidates, wherein each matching candidate is assigned an overall matching score;
iteratively executing:
sorting the matching candidates into sorted matching candidates by comparing the project attributes with matching candidate attributes and producing a resultant sorted matching candidate set;
breaking the sorted matching candidates into display groups;
sending a display group of the display groups to the user device;
receiving a display/sort trigger; and
revising the project attributes based on the display/sort trigger.

20. The non-transitory computer-readable medium of claim 19, wherein:
the display/sort trigger comprises a changing of the project attributes.
the changing of the project attributes results from a creation or changing of generated context attributes of the project attributes; and
the changing of the generated context attributes is based on at least one of the user-entered attributes, the matching candidate attributes, candidate attributes of the selected candidate, candidate attributes of historical candidates, a user action related to a displayed candidate of the display group, or project attributes of an additional project.
